(19) United States
(12) Patent Application Publication
(10) Pub. No.: US 2018/0374141 A1
(43) Pub. Date: Dec. 27, 2018

(54) INFORMATION PUSHING METHOD AND SYSTEM

(71) Applicant: Alibaba Group Holding Limited, Grand Cayman (KY)

(72) Inventors: Xin Zhou, Hangzhou (CN); Yangyang Kang, Hangzhou (CN); Changlong Sun, Hangzhou (CN); Jun Lang, Hangzhou (CN)

(21) Appl. No.: 16/020,437

(22) Filed: Jun. 27, 2018

(30) Foreign Application Priority Data
Jun. 27, 2017 (CN) 201710501465.9

(51) Int. Cl. G06Q 30/06; G06F 17/27; G06Q 30/02

(52) U.S. Cl. CPC G06Q 30/0631; G06Q 30/0255; G06F 17/2775

(57) ABSTRACT

The present application provides information pushing methods and systems. A demand object of a user is determined according to historical behavior data of the user, and user generated content (UGC) associated with the demand object of the user is pushed to the user, so that the pushed information is more credible. Further, the present application can be applied to an e-commerce website to increase users' purchasing power.

### CROSS REFERENCE TO RELATED PATENT APPLICATIONS

This application claims priority to Chinese Patent Application No. 201710501465.9, filed on Jun. 27, 2017 and entitled “INFORMATION PUSHING METHOD AND SYSTEM”, which is incorporated herein by reference in its entirety.

### TECHNICAL FIELD

The present application relates to the field of electronic information, and in particular, to information pushing methods and systems.

### BACKGROUND

With the increasing popularity of e-commerce, recommending commodities to users is an important research area. How to improve users' purchasing power by recommending commodities to the users is an urgent problem to be solved.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In the process of the research, the applicant found that simply recommending commodities to users did not have a significant effect on improvement of the purchasing power. However, sending user generated content (UGC), such as comments on commodities, to users can increase the purchasing power.

The present application provides information pushing methods and systems, aimed at solving the problem of how to send UGC on a website as pushed content.

In order to achieve the foregoing objective, the present application provides the following technical solutions.

An information pushing method includes:
determining a demand object of a user according to historical behavior data of the user;
selecting, from a plurality of pieces of UGC, piece(s) of UGC that satisfies a condition as candidate piece(s) of UGC, the condition including being related to the demand object of the user; and
pushing the candidate piece(s) of UGC to the user.

Optionally, the plurality of pieces of UGCs include high-quality pieces of UGC; and
any high-quality piece of UGC is a piece of UGC that includes preset key attributes and sentiment word features of a target object, the target object being an object which the high-quality piece of UGC concerns.

Optionally, the condition further includes:
a matching label, the label representing a preference of the user.

Optionally, pushing the candidate piece(s) of UGC to the user includes:
generating an information pushing list according to the candidate piece(s) of UGC and respective user label(s) of the candidate piece(s) of UGC, each piece of UGC in the information pushing list carrying a user label of the respective piece of UGC; and
pushing the information pushing list to the user.

Optionally, a process of generating the user label includes:
determining a capability label and/or a relation label of the respective candidate piece of UGC, the capability label denoting an experience level of a user who generated the respective candidate piece of UGC in a preset field, and the relation label denoting a relation between the user and the user who generated the respective candidate piece of UGC.

Optionally, a method of selecting the high-quality piece of UGCs includes:
extracting a feature from the piece of UGC, the feature including the key attributes and the sentiment word features;
multiplying the feature by a weight value of the feature to obtain an evaluation value of the piece of UGC; and
taking the piece of UGC as a high-quality piece of UGC when the evaluation value is greater than a preset threshold.

Optionally, extracting the feature from the piece of UGC includes:
performing word segmentation and word type marking on the piece of UGC; and
extracting the feature from the piece of UGC that has undergone the word segmentation and the word-type marking.

Optionally, the candidate piece of UGC does not include a piece of UGC of the user.

Optionally, the condition further includes:
being generated by the user.

An information pushing system, including:
a user demand mining module configured to determine a demand object of a user according to historical behavior data of the user;
a recommendation generation module configured to select, from a plurality of pieces of UGC, piece(s) of UGC that satisfies a condition as a candidate piece(s) of UGC, the condition including being related to the demand object of the user; and
a message pushing module configured to push the candidate piece(s) of UGC to the user.

Optionally, the plurality of pieces of UGC include high-quality pieces of UGC; and
any high-quality piece of UGC is a piece of UGC that includes preset key attributes and sentiment word features of a target object, the target object being an object which the high-quality piece of UGC concerns.

Optionally, the recommendation generation module is specifically configured to:
select, from multiple pieces of UGC, piece(s) of UGC that meets a condition as candidate piece(s) of UGC, the condition including being related to the demand object of the user, and the condition further including a matching label, the label representing the user's preference.

Optionally, the message pushing module is specifically configured to:
generate an information pushing list according to the candidate piece(s) of UGC and respective user label(s) of the candidate piece(s) of UGC, each piece of UGC in the information pushing list carrying a user label of the respective piece of UGC; and push the information pushing list to the user.

Optionally, the system further includes:
a user label relation calculation module configured to determine a capability label and/or a relation label of the respective candidate piece of UGC, the capability label denoting an experience level of a user who generated the respective candidate piece of UGC in a preset field, and the relation label denoting a relation between the user and the user who generated the respective candidate piece of UGC.

Optionally, the system further includes:
a high-quality UGC mining module configured to select the high-quality pieces of UGC according to the following process: extracting a feature from a piece of UGC, the feature including the key attributes and the sentiment word features; multiplying the feature by a weight value of the feature to obtain an evaluation value of the piece of UGC; and taking the piece of UGC as a high-quality piece of UGC when the evaluation value is greater than a preset threshold.

Optionally, the high-quality UGC mining module is specifically configured to:
perform word segmentation and word type marking on the piece of UGC; and extract the feature from the piece of UGC that has undergone the word segmentation and the word-type marking.

Optionally, the recommendation generation module is specifically configured to:
select, from multiple pieces of UGC, a piece of UGC that meets a condition as a candidate piece of UGC, wherein the candidate piece of UGC does not include a piece of UGC of the user, and the condition includes being related to the demand object of the user.

Optionally, the recommendation generation module is specifically configured to:
select, from multiple pieces of UGC, a piece of UGC that meets a condition as a candidate piece of UGC, the condition including being related to the demand object of the user, and the condition further including being created by the user.

An information pushing system, including:
a memory configured to store an application and data generated during execution of the application; and
a processor configured to execute the application stored in the memory to realize the following functions: determining a demand object of a user according to historical behavior data of the user; selecting, from a plurality of UGCs, a piece of UGC that satisfies a condition as a piece of candidate UGC, the condition including being related to the demand object of the user; and pushing the candidate piece of UGC to the user.

Optionally, the processor is specifically configured to: generate an information pushing list according to the piece of candidate UGC and a user label of the candidate piece of UGC, each piece of UGC in the information pushing list carrying a user label of the respective piece of UGC; and push the information pushing list to the user.

A computer readable storage medium, wherein the computer readable storage medium stores instructions which, when running on a computer, enable the computer to perform the following functions: determining a demand object of a user according to historical behavior data of the user; selecting, from a plurality of UGCs, a piece of UGC that satisfies a condition as a candidate piece of UGC, the condition including being related to the demand object of the user; and pushing the candidate piece of UGC to the user.

An information pushing method, including:
determining a demand object of a user according to historical behavior data of the user;
selecting, from a plurality of UGCs, a piece of UGC that satisfies a condition as a candidate piece of UGC, the condition including being related to the demand object of the user;
forming a recommended piece of UGC based on the candidate piece of UGC; and
pushing the recommended piece of UGC to the user.

Optionally, forming the recommended piece of UGC based on the candidate piece of UGC includes:
forming the recommended piece of UGC by simplifying content of the candidate piece of UGC.

Optionally, the condition further includes:
a matching label, the label representing a preference of the user.

According to the methods and systems of the present application, a demand object of a user is determined according to historical behavior data of the user, and a piece of UGC related to the demand object of the user is pushed to the user, so that the pushed information is more credible. Further, the present application can be applied to an e-commerce website to increase users' purchasing power.

### BRIEF DESCRIPTION OF THE DRAWINGS

To illustrate the technical solutions according to the embodiments of the present application more clearly, the accompanying figures required for describing the embodiments introduced briefly below. Apparently, the accompanying drawings in the following description merely represent some embodiments of the present application. One of ordinary skill in the art can further obtain other drawings according to the accompanying drawings without any creative effort.

FIG. 1 is a schematic structural diagram of an information pushing system according to an embodiment of the present application.

FIG. 2 is a flowchart of an information pushing method according to an embodiment of the present application.

FIG. 3 is a flowchart of a method of selecting high-quality UGCs according to an embodiment of the present application.

FIG. 4 is a flowchart of another information pushing method according to an embodiment of the present application.

FIG. 5(a) and FIG. 5(b) are schematic effect diagrams of an information pushing method according to an embodiment of the present application.

FIG. 6 is a block diagram of an information pushing system according to an embodiment of the present application.

### DETAILED DESCRIPTION

The information pushing method and system provided in the present application can be applied to a server of a website. A user registered with the website can publish User Generated Content (UGC) for an object displayed on the website. By taking an e-commerce website as an example, a user registered with the e-commerce website, after purchasing a commodity displayed on the e-commerce website, can make a comment on the purchased commodity (the comment is the user's UGC).

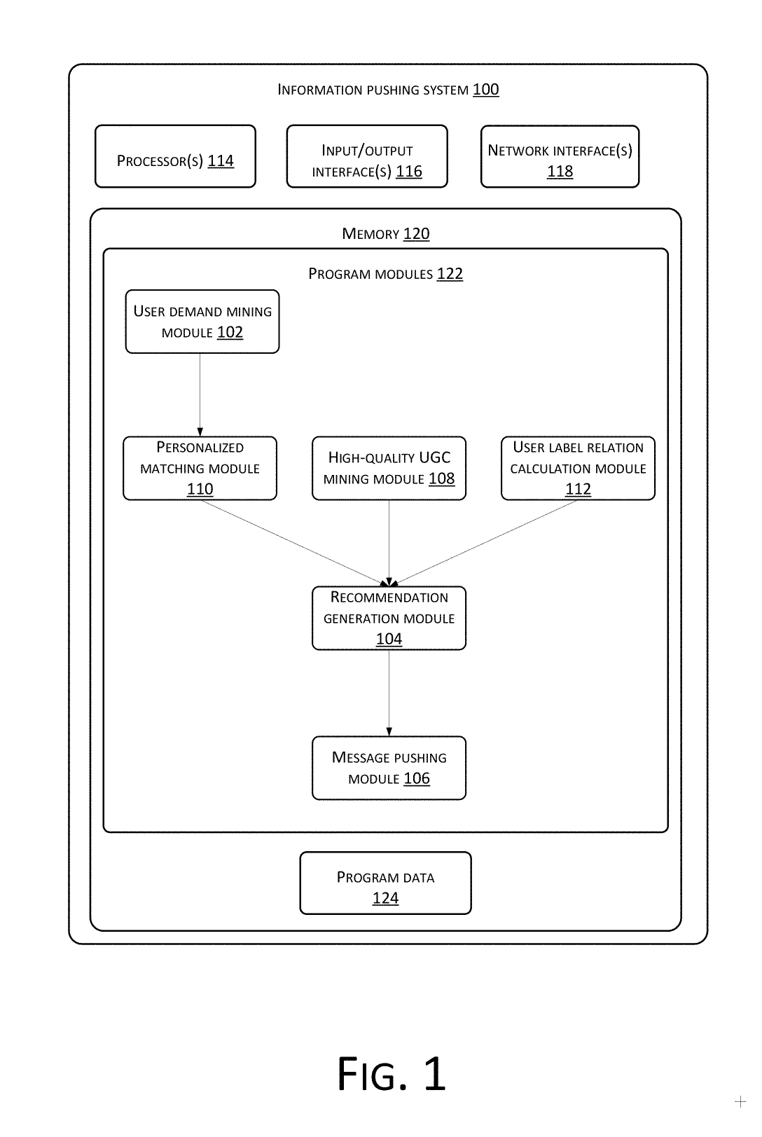

The information pushing method and system provided in the present application are aimed at pushing a user's UGC to users (which may also include the user) other than the user. FIG. 1 shows an example information pushing system 100 in accordance with an embodiment of the present disclosure. In implementations, the information pushing system 100 may include one or more computing devices. In implementations, the information pushing system 100 may be a part of one or more computing devices, e.g., run or implemented by the one or more computing devices. The one or more computing devices may be located at a single place, or distributed among a plurality of network devices through a network, e.g., a cloud. By way of example and not limitation, the structure of the information pushing system 100 provided in the present application is as shown in FIG. 1, including: a user demand mining module 102, a recommendation generation module 104, and a message pushing module 106. Optionally, the system further includes a high-quality UGC mining module 108, a personalized matching module 110, and a user label relation calculation module 112.

The information pushing system 100 may further include one or more processors 114, an input/output (I/O) interface 116, a network interface 118, and memory 120.

The memory 120 may include a form of computer readable media such as a volatile memory, a random access memory (RAM) and/or a non-volatile memory, for example, a read-only memory (ROM) or a flash RAM. The memory 120 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 120 may include program modules 122 and program data 124. The program modules 122 may include one or more of the modules as described above.

The functions of the modules in FIG. 1 are described below with reference to the drawings in the embodiments of the present application. It is apparent that the embodiments described represent merely some and not all of the embodiments of the present application. All other embodiments derived by those of ordinary skill in the art based on the embodiments in the present application without making any creative effort should all be encompassed in the scope of protection of the present application.

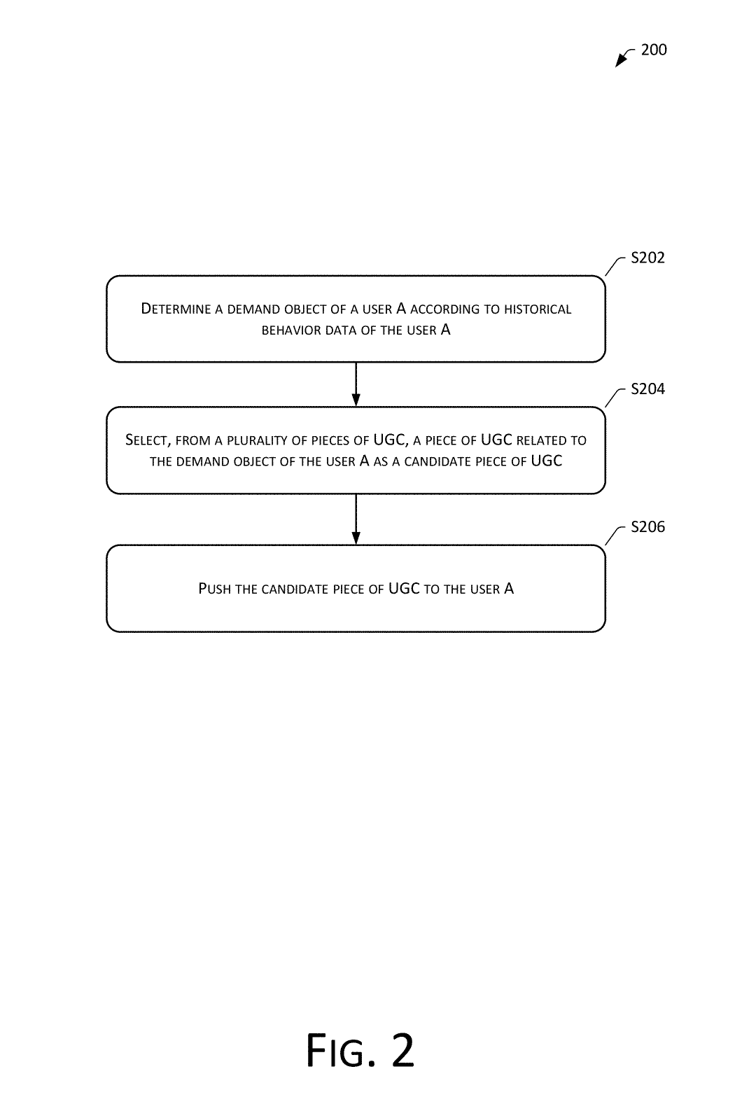

FIG. 2 shows an information pushing method 200 according to an embodiment of the present application, which includes the following operations:

S202: A user demand mining module determines a demand object of a user A according to historical behavior data of the user A.

The demand object of the user A is an object of an action that the user may perform, that is, an object of an operation instruction that may be issued by the user A. Specifically, in an e-commerce website, the demand object is at least one of a commodity that the user may bookmark, a commodity that the user may purchase, a commodity that the user may click to view, and a commodity that the user may add to a shopping cart.

Whether the user A may perform an action is determined according to historical behavior data of the user A.

For example, behavior data of the user A in the past seven days such as clicking, bookmarking, addition to the cart, searching, and purchase of commodities are collected based on a log of the website in the past seven days. A key product term and a brand term are extracted from the title of a commodity for which a historical action has occurred, to serve as a candidate demand commodity of the user. Different weights are assigned to different action modes. For example, the weight of the addition to the cart is 10, the weight of the bookmarking is 8, and the weight of the clicking is 5. Scores of the candidate demand commodities of the user are calculated according to action weights and action frequencies by using linear weighting, and commodities whose scores are lower than a score threshold are filtered out. Further, commodities that were purchased by the user in the past seven days can also be filtered out. The remaining commodities are demand objects of the user.

Optionally, after the candidate demand commodities of the user are determined in the foregoing example, weighted scoring may not be performed. Rather, commodities for which the action frequencies are lower than a threshold are filtered out from all the demand commodities of the user, and the remaining commodities are demand objects of the user.

S204: A recommendation generation module selects, from multiple pieces of UGC, a piece of UGC related to the demand object of the user A as a candidate piece of UGC.

The multiple pieces of UGC include high-quality pieces of UGC selected from pieces of UGC received by a website. In this embodiment, any piece of UGC in the high-quality pieces of UGC is a piece of UGC that includes key attributes of a target object and has preset sentiment word features. The target object is an object which the high-quality piece of UGC concerns. A high-quality piece of UGC from a user has reference significance to other users.

By taking an e-commerce website as an example, a high-quality piece of UGC is “It seems that Huang Xiaoniu is of little use in removing blackheads but has a really good skin care effect. It is easy to disperse and absorb and is not greasy. One or two drops can prevent the skin from being dry and tight the whole day. I had to like it.”

A non-high quality piece of UGC is “The commodity is of good quality and fast delivery. The seller's service and attitude are good.”

It can be seen that the high-quality piece of UGC includes key attributes “It is easy to disperse and absorb and is not greasy. Prevent from being dry and tight” of the commodity “Huang Xiaoniu” and sentiment word features “It has a really good skin care effect. I had to like it.” The non-high quality piece of UGC does not include key attributes and sentiment word features.

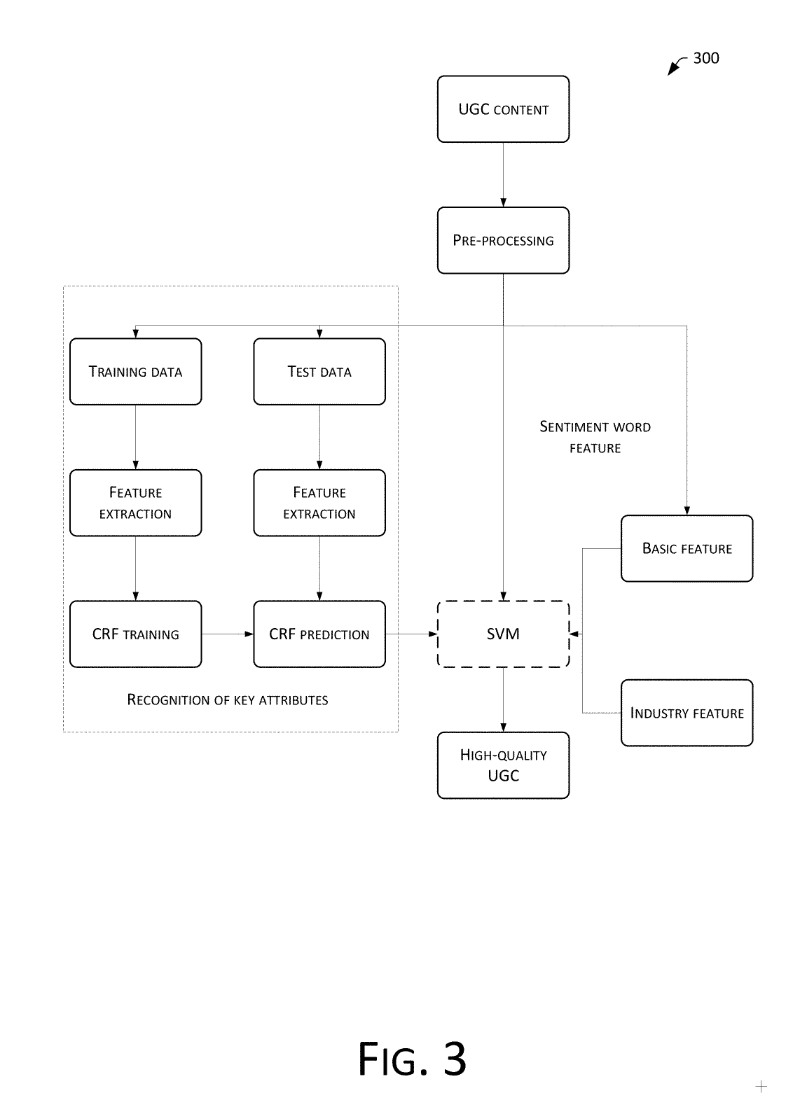

The multiple pieces of UGC can be included in a UGC library. The multiple pieces of UGC or the UGC library are/is created by the high-quality UGC mining module in FIG. 1. The method 300 of selecting the high-quality pieces of UGCs by the high-quality UGC mining module is as shown in FIG. 3:

First, a piece of UGC received by a website is pre-processed. The pre-processing includes, but is not limited to, word segmentation and word-type marking. Then, key attributes and sentiment word features are extracted from the pre-processed UGC. Optionally, basic features and industry features may also be extracted from the pre-processed UGC.

In particular, the key attributes of the object are key attributes of a category to which the object belongs, which can be preset. Different categories have different key attributes. For example, key attributes of the category women's wear are fabric, color, and so on. Key attributes of the category cosmetics are color fastness and so on.

As shown by the dashed box in FIG. 3, details of a process of extracting key attributes from the pre-processed UGC include: inputting the pre-processed UGC in a trained random field model, and outputting key attributes of the pre-processed UGC as shown by the procedure on the right of the dashed box. The procedure on the left of the dashed box is the training process of the random field model. Details of training methods can be referenced to existing technologies, and is not further detailed herein.

Sentiment word features are terms included in a preset sentiment word dictionary. Generally, the sentiment word dictionary includes positive words, such as very satisfied, excellent value for money, and the like, as well as negative words, such as shedding, swelling, and the like. The specific manner of extracting sentiment word features from the pre-processed UGC is extracting terms that belong to the sentiment word dictionary from the pre-processed UGC.

Basic features include, but are not limited to, sentence sentiment polarity, repetition of a text fragment, sentence length, correlation between the text and the object, similarity between the text and another text, user ratings, number of likes, and so on. In particular, the sentiment polarity refers to a sentiment classification, usually divided into three classifications (positive, negative and neutral). The sentence sentiment polarity is obtained by predicting a sentence based on a common sentiment analysis technology.

The industry features include, but are not limited to, various key attributes and attribute values given in the industry.

The key attributes and the sentiment word features extracted in the foregoing, optionally further including the basic features and the industry features, are input to a trained support vector machine (SVM) to obtain an evaluation value of the UGC. Specifically, the SVM is a linear model as shown in the formula (1), the output evaluation value is the product of a feature vector X and a weight vector W, and the range of the evaluation value is [0, 1].

score=W*X (1)

In particular, X denotes key attributes and sentiment word features, and optionally further includes basic features and industry features. The weight W of each feature is obtained by training the SVM in advance. In the process of training the SVM, features of an input sample include key attributes and sentiment word features, and optionally further include basic features and industry features. Training methods can be referenced to an existing technology.

After the score of a UGC is obtained, it is judged whether the score is greater than a preset threshold. If yes, the UGC is added into a UGC library; otherwise, the UGC is discarded.

The manner of obtaining an evaluation value by using a SVM in this embodiment is not the sole manner of determining the evaluation value, and the evaluation value may also be obtained according to the formula (1) in another manner.

Optionally, the high-quality UGC mining module can also perform a further selection of the multiple pieces of UGC or the pieces of UGC in the UGC library, that is, determine according to a log of a website whether a piece of UGC among the multiple pieces of UGC or the UGC library is shared by another user or has brought backflow (if the user A enters the e-commerce website through sharing of another user, it is referred to as backflow), and if no, delete the piece of UGC from the multiple pieces of UGC or the UGC library to reduce the data volume of the multiple pieces of UGC or the UGC library and increase the subsequent selection speed. Moreover, the quality of the UGC library and its appeal to users are further enhanced.

In S204, the piece of UGC in the UGC library which is related to the demand of the user A is a piece of UGC that is related to an object included in the user's demand. For example, if the demand of the user A is “lipstick”, the piece of UGC that is related to the demand of the user A is a piece of UGC whose content involves “lipstick”.

Optionally, the piece of UGC that is related to the demand of the user A does not include a piece of UGC of the user A, so that a commodity that has not been purchased by the user before can be recommended to the user, to increase the user's purchase probability.

Optionally, the piece of UGC that is associated with the demand of the user A can include a piece of UGC of the user A, that is, the high-quality piece of UGC created by the user A is pushed back to the user A, to promote a second purchase.

S206: A message pushing module pushes the candidate piece of UGC to the user A.

Specifically, an active time period of the user A can be determined according to historical behaviors of the user A, and information is pushed in the time period when the user A is relatively active. If the historical behaviors of the user A are sparse, the information is pushed in a fixed time period. The fatigue of the user A can also be calculated according to opening of messages by the user, to control the message pushing frequency.

It can be seen from the process shown in FIG. 2 that, in this embodiment, a demand of the user A is determined at first and a user UGC that is related to the demand of the user A is pushed to the user A. Therefore, the credibility of the commodity pushed to the user A can be enhanced, which is distinguished from the regular commodity recommendation and improves the probability that the user performs an operation on the recommended commodity.

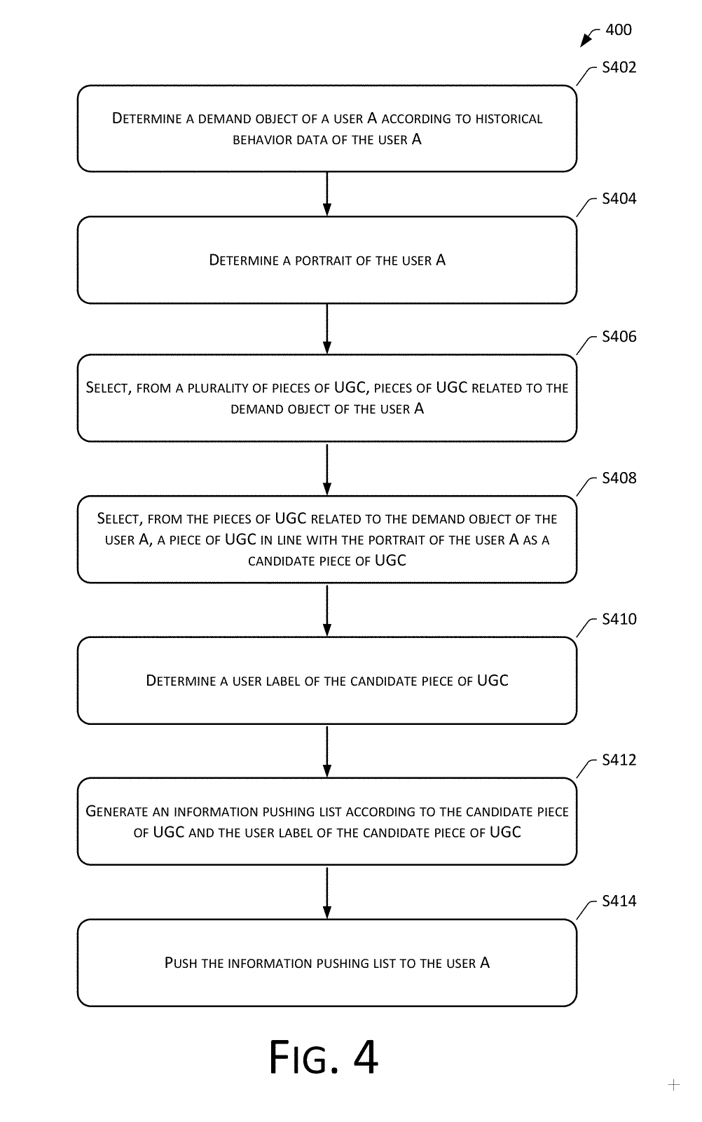

FIG. 4 shows another information pushing method 400 according to an embodiment of the present application. Different from the method shown in FIG. 2, the method further selects pieces of UGC related to the demand object of the user A based on a portrait of the user A, and a user label of a candidate piece of UGC is added in the pushed information.

FIG. 4 includes the following operations:

S402: A user demand mining module determines a demand object of a user A according to historical behavior data of the user A.

S404: A personalized matching module determines a portrait of the user A.

Specifically, the portrait of the user is labels of a preference of a user calculated according to demographic information and historical behavior data of the user registered in a website, which include, but are not limited to, gender, age, purchasing power, attribute preferences, and the like.

For example, the portrait of the user A is female, having high purchasing power, and having a preference for forest style.

S406: A recommendation generation module selects, from multiple pieces of UGC, pieces of UGC related to the demand object of the user A.

S408: The recommendation generation module selects a piece of UGC matched with the portrait of the user A from the pieces of UGC related to the demand object of the user A, to serve as a candidate piece of UGC.

For example, if the demand of the user A is a one-piece dress and the portrait of the user A is female, having high purchasing power, and having a preference for forest style, the candidate piece of UGC is a piece of UGC made for a one-piece dress by a female user who has high purchasing power and a preference for forest style and/or a piece of UGC made by a female user for a one-piece dress with a high price and in a forest style.

S410: A user label relation calculation module determines a user label of the candidate piece of UGC.

In this embodiment, the user label includes, but is not limited to, a capability label and a relation label. The capability label refers to an experience level of the user in a preset field, for example, “digital expert”, “mother”, “fashionable man” and so on. The relation label refers to a relation between the user of the candidate piece of UGC (that is, the user who generated the candidate piece of UGC) and the user A, for example, “Taobao™ friends”, “users of the same stature”, and so on.

SS412: The recommendation generation module generates an information pushing list according to the candidate piece of UGC and the user label of the candidate piece of UGC.

All the candidate pieces of UGC in the information pushing list can be scored according to various objects based on a preset rule and are sorted according to the scores. Each piece of UGC carries a user label of the UGC.

S414: A message pushing module pushes the information pushing list to the user A.

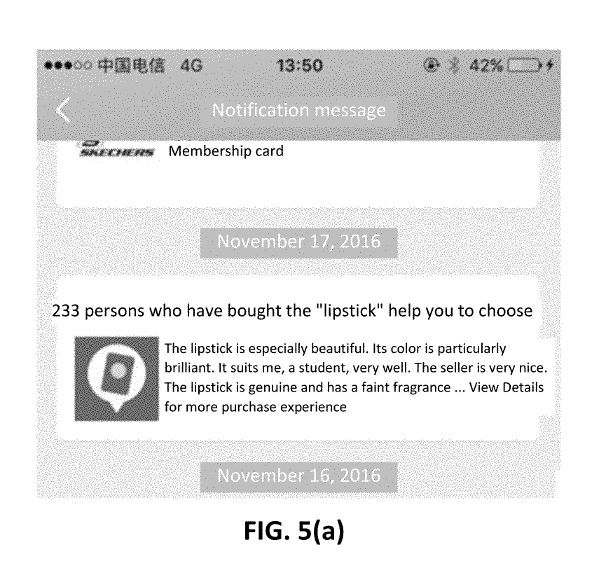

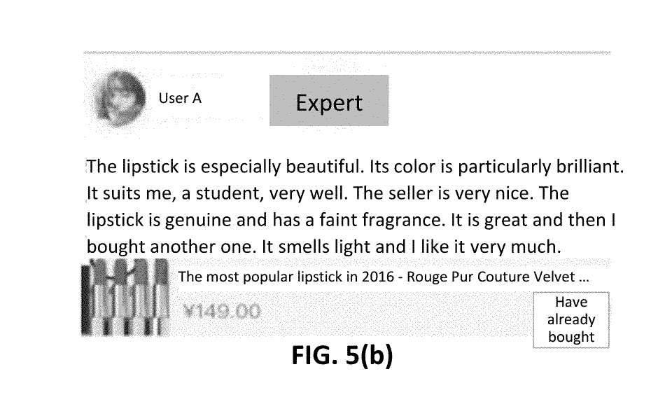

The method shown in FIG. 4 achieves the effect shown in FIG. 5(b): the user A receives pushed information, and FIG. 5(b) displays a piece of UGC of “lipstick” with the highest score, including an image, commodity information of the piece of UGC, and the user label “expert” of the piece of UGC.

The information pushing method in this embodiment may push to a user purchase evaluation of other users (the user himself/herself may also be included), thus increasing the credibility of the recommended content. Moreover, it is costly for the user to find the real experience content among massive quantities of commodity UGC content, and the content is likely to be missed. However, the method provided in the present application selects pieces of UGC, which thus helps the user to save the decision-making cost. Further, the pieces of UGC provide information in more dimensions from the perspective of users, which is an advantage that the existing direct commodity recommendation does not have.

Further, in the process shown in FIG. 3 or FIG. 4, after the candidate UGC is determined, a recommended piece of UGC can also be formed according to the candidate piece of UGC, and the recommended piece of UGC is pushed to the user. The recommended piece of UGC is a simplified content of the candidate piece of UGC. By taking FIG. 5(a) as an example, the user A receives a simplified content of the piece of UGC of “lipstick” with the highest information pushing score. When the user A clicks the simplified content of the piece of UGC or clicks “View Details”, the complete content of the piece of UGC shown in FIG. 5(b) is displayed.

In combination with the process shown in FIG. 4, after S410, the candidate piece of UGC can be simplified to generate a recommended piece of UGC, a push list is generated according to the recommended piece of UGC and the user label of the candidate piece of UGC, and the push list is pushed to the user A.

Pushing the simplified content of the piece of UGC to the user not only can save the quantity of data transmitted but also can help users to understand the pushed content more efficiently. A user can click the simplified content of the piece of UGC to further understand all the content of the piece of UGC if the user is interested in it.

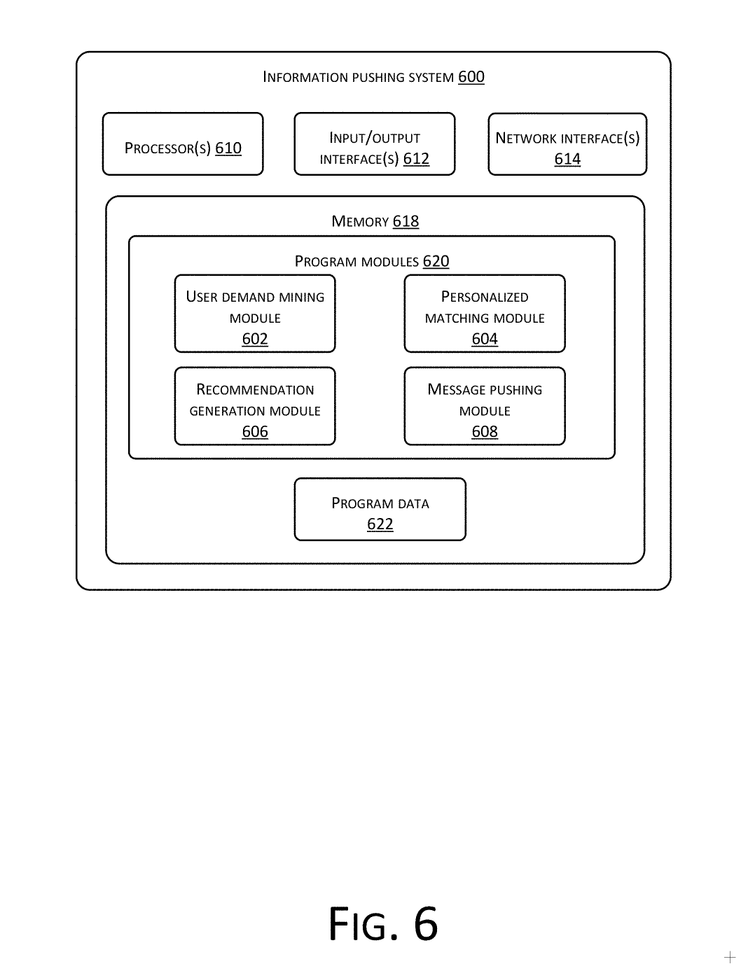

An embodiment of the present application further discloses an information pushing system 600. FIG. 6 is a block diagram of an example embodiment of an information pushing system provided by the present disclosure. In implementations, the information pushing system may include one or more computing devices. In implementations, the information pushing system may be a part of one or more computing devices which are located at a single place, or distributed among a plurality of network devices through a network. By way of example and not limitation, according to FIG. 6, the information pushing system 600 may include: a user demand mining module 602, a personalized matching module 604, a recommendation generation module 606, and a message pushing module 608.

The information pushing system 600 may further include one or more processors 610, an input/output (I/O) interface 612, a network interface 614, and memory 618. The memory 618 is configured to store an application and data generated during execution of the application. The processor 610 is configured to execute the application stored in the memory to realize the processes shown in FIG. 2, FIG. 3 and FIG. 4.

An embodiment of the present application further discloses a computer readable storage medium, wherein the computer readable storage medium stores instructions which, when running on a computer, enable the computer to perform the processes shown in FIG. 2, FIG. 3 and FIG. 4.

The memory 618 may include a form of computer readable media medias described in the foregoing description. In implementations, the memory 618 may include program modules 620 and program data 622. The program modules 620 may include one or more of the modules as described in above.

When the functions in the methods according to the embodiments of the present application are implemented in the form of a software functional unit and sold or used as an independent product, the product may be stored in a computing device readable storage medium. Based on such an understanding, the part of the embodiments of the present application contributing to the prior art ora part of the technical solutions may be embodied in a form of a software product. The software product is stored in a storage medium and includes several instructions for instructing a computing device (which may be a personal computer, a server, a mobile computing device, a network device, or the like) to perform all or a part of the operations of the methods described in the embodiments of the present application.

The embodiments in the specification are described progressively, each embodiment emphasizes a part different from other embodiments, and identical or similar parts of the embodiments may be obtained by reference to each other.

The above descriptions about the disclosed embodiments enable those skilled in the art to implement or use the present application. A variety of modifications to the embodiments will be obvious for those skilled in the art. General principles defined in this text can be implemented in other embodiments without departing from the spirit or scope of the present application. Therefore, the present application will not be limited to the embodiments shown in this text and will be in line with the broadest scope consistent with the principles and novelties disclosed in this text.

What is claimed is:

1. An information pushing method, comprising:
determining a demand object of a user according to historical behavior data of the user;
selecting, from a plurality of pieces of user generated content (UGC), at least one piece of UGC that satisfies a condition as at least one candidate piece of UGC, the condition comprising being related to the demand object of the user; and
pushing the at least one candidate piece of UGC to the user.

2. The method of claim 1, wherein the plurality of pieces of UGC comprise high-quality pieces of UGCs; and
any high-quality piece of UGC is a piece of UGC that comprises preset key attributes and sentiment word features of a target object, the target object being an object which the high-quality piece of UGC concerns.

3. The method of claim 1, wherein the condition further comprises:
a matching label, the label representing a preference of the user.

4. The method of claim 1, wherein pushing the at least one candidate piece of UGC to the user comprises:
generating an information pushing list according to the at least one candidate piece of UGC and at least one user label of the at least one candidate piece of UGC, each piece of UGC in the information pushing list carrying a user label of the respective piece of UGC; and
pushing the information pushing list to the user.

5. The method of claim 4, wherein a process of generating a user label comprises:
determining a capability label and/or a relation label of a candidate piece of UGC, the capability label denoting an experience level of a user who generated the candidate piece of UGC in a preset field, and the relation label denoting a relation between the user and the user who generated the candidate UGC.

6. The method of claim 2, wherein an approach of selecting the high-quality UGCs comprises:
extracting a feature from a piece of UGC, the feature comprising the key attributes and the sentiment word features;
multiplying the feature by a weight value of the feature to obtain an evaluation value of the UGC; and
taking the piece of UGC as a high-quality UGC when the evaluation value is greater than a preset threshold.

7. The method of claim 6, wherein extracting the feature from the piece of UGC comprises:
performing word segmentation and word type marking on the piece of UGC; and
extracting the feature from the piece of UGC that has undergone the word segmentation and the word-type marking.

8. The method of claim 6, wherein the at least one candidate piece of UGC does not comprise a piece of UGC of the user.

9. The method of claim 6, wherein the condition further comprises:
being generated by the user.

10. An information pushing system, comprising:
a user demand mining module configured to determine a demand object of a user according to historical behavior data of the user;
a recommendation generation module configured to select, from a plurality of pieces of user generated contents (UGC), at least one piece of UGC that satisfies a condition as at least one candidate piece of UGC, the condition comprising being related to the demand object of the user; and
a message pushing module configured to push the at least one candidate piece of UGC to the user.

11. The system of claim 10, wherein the plurality of pieces of UGC comprise high-quality pieces of UGCs; and
any high-quality piece of UGC is a piece of UGC that comprises preset key attributes and sentiment word features of a target object, the target object being an object which the high-quality piece of UGC concerns.

12. The system of claim 10, wherein the recommendation generation module is further configured to:
select, from the plurality of UGCs, at least one piece of UGC that satisfies the condition as the at least one candidate piece of UGC, the condition comprising being related to the demand object of the user, and the condition further comprises a matching label, the label representing a preference of the user.

13. The system of claim 10, wherein the message pushing module is further configured to:
generate an information pushing list according to the at least one candidate piece of UGC and at least one user label of the at least one candidate piece of UGC, each UGC in the information pushing list carrying a user label of the respective piece of UGC; and push the information pushing list to the user.

14. The system of claim 13, further comprising:
a user label relation calculation module configured to determine a capability label and/or a relation label of a candidate piece of UGC, the capability label denoting an experience level of a user who generated the candidate piece of UGC in a preset field, and the relation label denoting a relation between the user and the user who generated the candidate piece of UGC.

15. The system of claim 11, further comprising:
a high-quality UGC mining module configured to select the high-quality pieces of UGC according to the following process: extracting a feature from a piece of UGC, the feature comprising the key attributes and the sentiment word features; multiplying the feature by a weight value of the feature to obtain an evaluation value of the piece of UGC; and taking the piece of UGC as a high-quality UGC when the evaluation value is greater than a preset threshold.

16. The system of claim 15, wherein the high-quality UGC mining module is further configured to:
perform word segmentation and word type marking on the piece of UGC; and extract the feature from the piece of UGC that has undergone the word segmentation and the word-type marking.

17. The system of claim 15, wherein the recommendation generation module is further configured to:
select, from the plurality of pieces of UGC, at least one piece of UGC that satisfies a condition as at least one candidate piece of UGC, wherein the at least one candidate piece of UGC does not comprise a UGC piece of the user, and the condition comprises being related to the demand object of the user.

18. The system of claim 15, wherein the recommendation generation module is further configured to:
select, from the plurality of pieces of UGCs, at least one piece of UGC that meets a condition as at least one candidate piece of UGC, the condition comprising being related to the demand object of the user, and the condition further comprising being generated by the user.

19. An information pushing system, comprising:
a memory configured to store an application and data generated during execution of the application; and
a processor configured to execute the application stored in the memory to realize the following functions: determining a demand object of a user according to historical behavior data of the user; selecting, from a plurality of pieces of user generated content (UGC), at least one piece of UGC that satisfies a condition as at least one candidate piece of UGC, the condition comprising being related to the demand object of the user; and pushing the at least one candidate piece of UGC to the user.

20. The system of claim 19, wherein the processor is further configured to:
generate an information pushing list according to the at least one candidate piece of UGC and a user label of the at least one candidate piece of UGC, each piece of UGC in the information pushing list carrying a user label of the respective piece of UGC; and push the information pushing list to the user.
